(19) United States
(12) Patent Application Publication
(10) Pub. No.: US 2024/0066669 A1
(43) Pub. Date: Feb. 29, 2024

(54) HIGH-PRECISION AND HIGH-TORSION RATCHET WRENCH

(71) Applicant: Zhejiang Toolking Hardware & Tools Co.,Ltd., Shaoxing (CN)

(72) Inventors: Chin-man CHANG, Shaoxing (CN); Fong-chi CHANG, Shaoxing (CN)

(73) Assignee: Zhejiang Toolking Hardware & Tools Co.,Ltd., Shaoxing (CN)

(21) Appl. No.: 17/993,221

(22) Filed: Nov. 23, 2022

(30) Foreign Application Priority Data
Aug. 23, 2022 (CN) 202211011945.4
Aug. 23, 2022 (CN) 202222218274.0

(51) Int. Cl. B25B 13/46; B25B 13/48

(52) U.S. Cl. CPC B25B 13/463; B25B 13/481

(57) ABSTRACT

A high-precision and high-torsion ratchet wrench comprises a handle head. A center mounting through hole is formed in the middle of a top surface of the handle head. A ratchet head is inserted into the center mounting through hole. A first outer tooth part and a second outer tooth part which longitudinally correspond to each other are formed on an outer wall of the ratchet head. Teeth of the first outer tooth part are located right above the middle of corresponding tooth sockets of the second outer tooth part. Teeth of the second outer tooth part are located right below the middle of corresponding tooth sockets of the first outer tooth part. The first outer tooth part and the second outer tooth part are disposed on the outer wall of the ratchet head.

### CROSS-REFERENCE TO RELATED APPLICATIONS

This application claims priority to Chinese Patent Application No. 202211011945.4, filed on Aug. 23, 2022, and Chinese Patent Application No. 202222218274.0, filed on Aug. 23, 2022. The disclosures of the aforementioned applications are incorporated in this application by reference in their entireties.

### TECHNICAL FIELD

The application relates to the technical field of fastener tools, in particular to a high-precision and high-torsion ratchet wrench.

### BACKGROUND

Existing ratchet wrenches have at most 90 teeth and a minimum rotation angle of 4°, so they cannot rotate in smaller spaces to tighten screws and have a limited effect. Chinese Patent Application No. 201922467295.4 provides a high-precision and high-torsion ratchet wrench provided with 120 teeth, wherein 120 teeth are formed on an outer wall of a ratchet head of the ratchet wrench, so the ratchet wrench has a minimum rotation angle of 3° and can rotate in smaller spaces to tighten screws, thus having a wider application range. Moreover, the screwing direction of the ratchet wrench is adjusted through leftward and rightward movement of a single adjustment stop, so the ratchet wrench is high in strength, not prone to damage and long in service life, and the precision of the rotation angle of the ratchet wrench is further improved. However, the ratchet wrench cannot be used in some even smaller spaces, so the use effect of the ratchet wrench is limited; and if more teeth, such as 180 teeth, are blindly formed on the outer wall of the ratchet head, these teeth will be extremely small, which will make the torsion of the ratchet wrench too small, make the teeth prone to breakage, and compromise the service life of the ratchet wrench.

### SUMMARY

The objective of the application is to overcome the defects of the prior art to provide a high-precision and high-torsion ratchet wrench. According to the high-precision and high-torsion ratchet wrench, a first outer tooth part and a second outer tooth part are disposed on an outer wall of a ratchet head, and teeth of the first outer tooth part are longitudinally staggered with and correspond to teeth of the second outer tooth part, which means that the number of rotating teeth of the ratchet wrench is the sum of the number of the teeth of the first outer tooth part and the number of the teeth of the second outer tooth part, such that the rotation precision of the ratchet wrench is improved under the precondition that high torsion is guaranteed, the application range of the ratchet wrench is greatly widened, and the ratchet wrench can be used in a small rotating space and is good in use effect and long in service life.

The solution adopted by the application to solve the technical problems is as follows:

A high-precision and high-torsion ratchet wrench comprises a handle head, wherein a center mounting through hole is formed in the middle of a top surface of the handle head, a lower adjustment groove which extends backwards is formed in an inner wall of the middle of a rear portion of the center mounting through hole, a mounting through hole which extends upwards is formed in a bottom surface of the rear portion of the handle head and is communicated with the lower adjustment groove, a middle portion and a rear portion of the mounting through hole are located behind the lower adjustment groove, a ratchet head is inserted into the center mounting through hole, a first outer tooth part and a second outer tooth part which longitudinally correspond to each other are formed on an outer wall of the ratchet head, teeth of the first outer tooth part are located right above the middle of corresponding tooth sockets of the second outer tooth part, and teeth of the second outer tooth part are located right below the middle of corresponding tooth sockets of the first outer tooth part.

A first adjustment stop and a second adjustment stop which are longitudinally stacked together are inserted into the lower adjustment groove, front wall surfaces of the first adjustment stop and the second adjustment stop are arc-shaped wall surfaces, and tooth profile parts are formed on the arc-shaped wall surfaces and are matched with the corresponding first outer tooth part or second outer tooth part.

A vertical column of a steering gear is inserted into the mounting through hole, two side mounting through holes which longitudinally correspond to each other are formed in a front wall of the vertical column, two hollow locating pins are inserted into the two side mounting through holes, butter springs are inserted into the side mounting through holes, rear ends of the buffer springs abut against inner end faces of the side mounting through holes, the buffer springs are inserted into the hollow locating pins, front ends of the buffer springs abut against inner walls of front ends of the hollow locating pins, the front ends of the hollow locating pins stretch out of the side mounting through holes to be located in the lower adjustment groove and are inserted into a center groove formed in the middle of a rear wall surface of the first adjustment stop or the second adjustment stop, an inner wall surface of the center groove is an arc-shaped wall surface, front wall surfaces of the hollow locating pins are spherical wall surfaces and press against inner wall surfaces of the corresponding center grooves.

The first outer tooth part is located above the second outer tooth part, a first adjustment stop is located above a second adjustment stop, the first outer tooth part corresponds to the first adjustment stop, and the second outer tooth part corresponds to the second adjustment stop.

Inner wall surfaces of left and right sides of the lower adjustment groove are arc-shaped wall surfaces, and left and right walls of a first adjustment stop and a second adjustment stop are matched with the arc-shaped wall surfaces of the lower adjustment groove.

A driving head which extends upwards vertically is disposed in the middle of a top surface of the ratchet head.

An extension which extends backwards is formed at a rear end of the handle head.

The steering gear comprises a bottom rotating part, a vertical column is formed on a top surface of a front portion of the bottom rotating part, and a rear wall surface of the vertical column clings to an inner wall of the mounting through hole; and a groove which extends backwards is formed in a bottom surface of the handle head at a bottom of the mounting through hole, a rear portion of the bottom rotating part is located in the groove, and a top surface of the rear portion of the bottom rotating part presses against a top surface of the groove.

A kidney-shaped groove is formed in the middle of the top surface of the handle head, the center mounting through hole, the lower adjustment groove and the mounting through hole are all located in a bottom surface of the middle of the kidney-shaped groove, a cover plate is inserted into the kidney-shaped groove, a bottom surface of the cover plate presses against a bottom surface of the kidney-shaped groove, and the cover plate is fixedly connected to the handle head through bolts.

A driving head which extends upwards vertically is disposed in the middle of a top surface of the ratchet head and stretches out of a through hole in the cover plate.

The first outer tooth part and the second outer tooth part are each composed of 90 teeth, and the teeth of the first outer tooth part are longitudinally staggered with and correspond to the teeth of the second outer tooth part.

The application has the following prominent effects:

Compared with the prior art, the first outer tooth part and the second outer tooth part are disposed on the outer wall of the ratchet head, and the teeth of the first outer tooth part are longitudinally staggered with and correspond to the teeth of the second outer tooth part, which means that the number of rotating teeth of the ratchet wrench is the sum of the number of the teeth of the first outer tooth part and the number of the teeth of the second outer tooth part, such that the rotation precision of the ratchet wrench is improved under the precondition that high torsion is guaranteed, the application range of the ratchet wrench is greatly widened, and the ratchet wrench can be used in a small rotating space and is good in use effect and long in service life.

### BRIEF DESCRIPTION OF THE DRAWINGS

FIG. 1 is a structural diagram of the application.

FIG. 2 is a partial structural view of the application from another perspective.

FIG. 3 is an exploded view of the application.

FIG. 4 is a partial sectional view of the application.

FIG. 5 is a partial enlarged view of FIG. 4.

FIG. 6 is a partial enlarged view of FIG. 5.

### DETAILED DESCRIPTION OF THE EMBODIMENTS

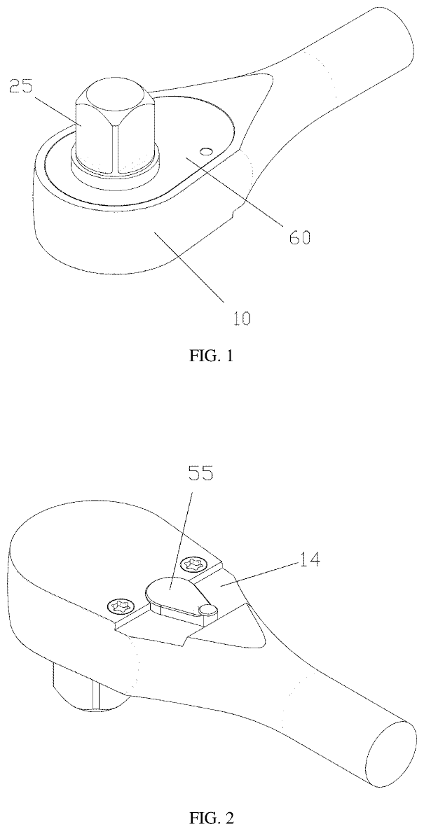

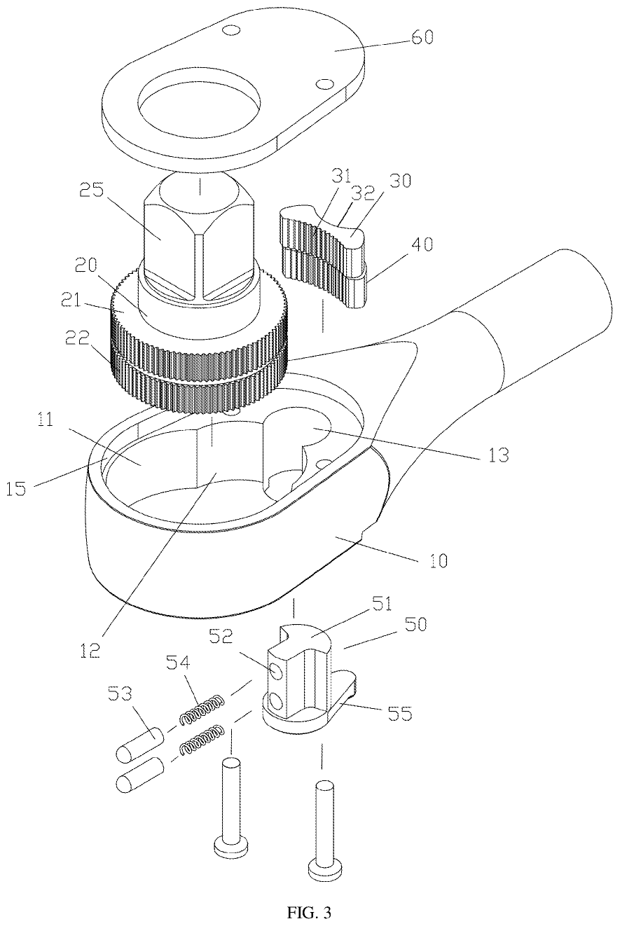

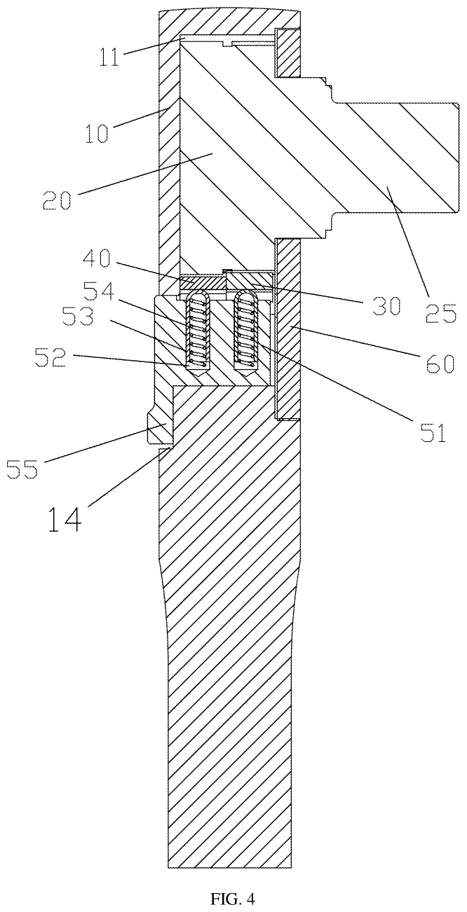

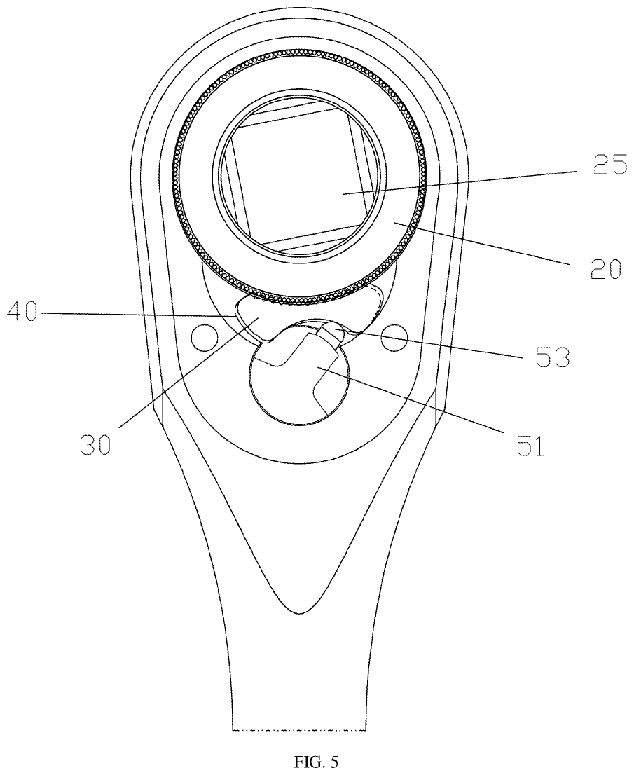

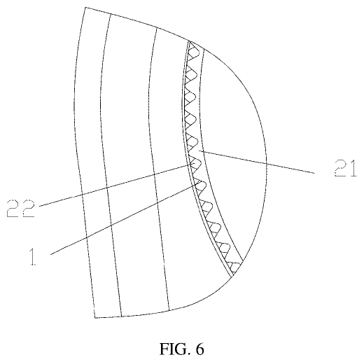

Embodiment: As shown in FIG. 1-FIG. 6, a high-precision and high-torsion ratchet wrench comprises a handle head 10, wherein a center mounting through hole 11 is formed in the middle of a top surface of the handle head 10, a lower adjustment groove 12 which extends backwards is formed in an inner wall of the middle of a rear portion of the center mounting through hole 11, a mounting through hole 13 which extends upwards is formed in a bottom surface of the rear portion of the handle head 11 and is communicated with the lower adjustment groove 12, a middle portion and a rear portion of the mounting through hole 13 are located behind the lower adjustment groove 12, a ratchet head 20 is inserted into the center mounting through hole 11, a first outer tooth part 21 and a second outer tooth part 22 which longitudinally correspond to each other are formed on an outer wall of the ratchet head 20, teeth of the first outer tooth part 21 are located right above the middle of corresponding tooth sockets 1 of the second outer tooth part 22, and teeth of the second outer tooth part 22 are located right below the middle of corresponding tooth sockets 1 of the first outer tooth part 21.

Further, a first adjustment stop 30 and a second adjustment stop 40 which are longitudinally stacked together are inserted into the lower adjustment groove 12, front wall surfaces of the first adjustment stop 30 and the second adjustment stop 40 are arc-shaped wall surfaces, and tooth profile parts 31 are formed on the arc-shaped wall surfaces and are matched with the corresponding first outer tooth part 21 or second outer tooth part 22.

Further, a vertical column 51 of a steering gear 50 is inserted into the mounting through hole 13, two side mounting through holes 52 which longitudinally correspond to each other are formed in a front wall of the vertical column 51, two hollow locating pins 53 are inserted into the two side mounting through holes 52, butter springs 54 are inserted into the side mounting through holes 52, rear ends of the buffer springs 54 abut against inner end faces of the side mounting through holes 52, the buffer springs 54 are inserted into the hollow locating pins 53, front ends of the buffer springs 54 abut against inner walls of front ends of the hollow locating pins 53, the front ends of the hollow locating pins 53 stretch out of the side mounting through holes 52 to be located in the lower adjustment groove 12 and are inserted into a center groove 32 formed in the middle of a rear wall surface of the first adjustment stop 30 or the second adjustment stop 40, an inner wall surface of the center groove 32 is an arc-shaped wall surface, front wall surfaces of the hollow locating pins 53 are spherical wall surfaces and press against inner wall surfaces of the corresponding center grooves 32.

Further, the first outer tooth part 21 is located above the second outer tooth part 22, the first adjustment stop 30 is located above the second adjustment stop 40, the first outer tooth part 21 corresponds to the first adjustment stop 30, and the second outer tooth part 22 corresponds to the second adjustment stop 40.

Further, inner wall surfaces of left and right sides of the lower adjustment groove 12 are arc-shaped wall surfaces, and left and right walls of the first adjustment stop 30 and the second adjustment stop 40 are matched with the arc-shaped wall surfaces of the lower adjustment groove 12.

Further, a driving head 25 which extends upwards vertically is disposed in the middle of a top surface of the ratchet head 20, and the driving head 25 is a square head.

Further, an extension which extends backwards is formed at a rear end of the handle head 10. The extension in the figures is merely illustrative, and generally, the extension extends further backwards to directly form a handle.

Further, the steering gear 50 comprises a bottom rotating part 55, the vertical column 51 is formed on a top surface of a front portion of the bottom rotating part 55, and a rear wall surface of the vertical column 51 clings to an inner wall of the mounting through hole 13; and a groove 14 which extends backwards is formed in a bottom surface of the handle head 10 at the bottom of the mounting through hole 13 and is communicated with the bottom of the mounting through hole 13, a rear portion of the bottom rotating part 55 is located in the groove 14, and a top surface of the rear portion of the bottom rotating part 55 presses against a top surface of the groove 14.

Further, a kidney-shaped groove 15 is formed in the middle of the top surface of the handle head 10, the center mounting through hole 11, the lower adjustment groove 12 and the mounting through hole 13 are all located in a bottom surface of the middle of the kidney-shaped groove 15, a cover plate 60 is inserted into the kidney-shaped groove 15, a bottom surface of the cover plate 60 presses against a bottom surface of the kidney-shaped groove 15, and the cover plate 60 is fixedly connected to the handle head 10 through bolts.

Further, the driving head 25 which extends upwards is formed in the middle of the top surface of the ratchet head 20, and the top of the driving head 25 stretches out of a through hole 61 in the cover plate 60.

Further, the first outer tooth part 21 and the second outer tooth part 22 are each composed of 90 teeth, and the teeth of the first outer tooth part 21 are longitudinally staggered with and correspond to the teeth of the second outer tooth part 22. During the production process, the first outer tooth part 21 and the second outer tooth part 22 may be designed with 70 teeth, 60 teeth or the like according to design or production requirements, as long as the teeth of the first outer tooth part 21 are longitudinally staggered with and correspond to the teeth of the second outer tooth part 22, such that the precision of the rotation angle is improved under the precondition that the torsion is guaranteed or increased.

When the high-precision and high-torsion ratchet wrench in this embodiment is used, the rear portion of the bottom rotating part 55 of the steering gear 50 is manually rotated to enable the vertical column 51 to rotate, so the hollow locating pins 53 are driven to rotate to enable the first adjustment stop 30 and the second adjustment stop 40 to move leftwards or rightwards along the arc-shaped wall surfaces of the lower adjustment groove 13; and when the first adjustment stop 30 and the second adjustment stop 40 move in place, the tooth profile part 31 of the first adjustment stop 30 or the second adjustment stop 40 is matched with the corresponding first outer tooth part 21 or the second outer tooth part 22. Specifically, in one case, the tooth profile part 31 of the first adjustment stop 30 is engaged with the corresponding teeth of the first outer tooth part 21, and the tooth profile part 31 of the second adjustment stop 40 is not completely engaged with the corresponding teeth of the second outer tooth part 22; in the other case, the tooth profile part 31 of the second adjustment stop 40 is engaged with the corresponding teeth of the second outer tooth part 22, and the tooth profile part 31 of the first adjustment stop 30 is not completely engaged with the corresponding teeth of the first outer tooth part 21.

At this moment, the ratchet head 20 is rotated, and along with the rotation of the ratchet head 20, the first outer tooth part 21 is completely engaged with the corresponding profile part 31 of the first adjustment stop 30, and the second outer tooth part 22 is separated from the corresponding tooth profile part 31 of the second adjustment stop 40 to realize incomplete engagement, and at this point, the angle of the ratchet wrench is 2° (in this embodiment, the first outer tooth part 21 and the second outer tooth part 22 are each composed of 90 teeth, that is, the ratchet wrench is provided with 180 teeth in total, so the angle 2° of the ratchet wrench is obtained by dividing 360° by 180). That is, the minimum angle of the ratchet wrench in this embodiment is 2°, so the ratchet wrench can rotate in even smaller spaces to tighten bolts, thus having a wider application range. Similarly, in the other case, the first outer tooth part 21 is separated from the corresponding tooth profile part 31 of the first adjustment stop 30 to realize incomplete engagement, and the second outer tooth part 22 is completely engaged with the corresponding tooth profile part 31 of the second adjustment stop 40.

In this embodiment, the first outer tooth part 21 and the second outer tooth part 22 which longitudinally correspond to each other are formed on the outer wall of the ratchet head 20, the teeth of the first outer tooth part 21 are located right above corresponding tooth sockets 1 of the second outer tooth part 22, and teeth of the second outer tooth part 22 are located right below corresponding tooth sockets 1 of the first outer tooth part 21, so the strength of the teeth of the first outer tooth part 21 and the second outer tooth part 22 of the ratchet head 20 is guaranteed, the precision of the rotation angle of the ratchet wrench is improved under the precondition that the torsion is guaranteed, the application range of the ratchet wrench is greatly widened, and the ratchet wrench can be used in even smaller rotating spaces and is good in use effect and long in service life.

Finally, the above embodiments are merely used to explain the application, and are not intended to limit the application. Various modifications and transformations can be made by those ordinarily skilled in the art without departing from the spirit and scope of the application. Thus, all equivalent technical solutions should fall within the scope of the application, and the patent protection scope of the application should be defined by the claims.

What is claimed is:

1. A high-precision and high-torsion ratchet wrench, comprising a handle head, a center mounting through hole being formed in a middle of a top surface of the handle head, a lower adjustment groove which extends backwards being formed in an inner wall of a middle of a rear portion of the center mounting through hole, a mounting through hole which extends upwards being formed in a bottom surface of the rear portion of the handle head and being communicated with the lower adjustment groove, and a middle portion and a rear portion of the mounting through hole being located behind the lower adjustment groove,
wherein a ratchet head is inserted into the center mounting through hole, a first outer tooth part and a second outer tooth part which longitudinally correspond to each other are formed on an outer wall of the ratchet head, teeth of the first outer tooth part are located right above a middle of corresponding tooth sockets of the second outer tooth part, and teeth of the second outer tooth part are located right below a middle of corresponding tooth sockets of the first outer tooth part.

2. The high-precision and high-torsion ratchet wrench according to claim 1, wherein a first adjustment stop and a second adjustment stop which are longitudinally stacked together are inserted into the lower adjustment groove, front wall surfaces of the first adjustment stop and the second adjustment stop are arc-shaped wall surfaces, and tooth profile parts are formed on the arc-shaped wall surfaces and are matched with the corresponding first outer tooth part or second outer tooth part.

3. The high-precision and high-torsion ratchet wrench according to claim 1, wherein a vertical column of a steering gear is inserted into the mounting through hole, two side mounting through holes which longitudinally correspond to each other are formed in a front wall of the vertical column, two hollow locating pins are inserted into the two side mounting through holes, butter springs are inserted into the side mounting through holes, rear ends of the buffer springs abut against inner end faces of the side mounting through holes, the buffer springs are inserted into the hollow locating pins, front ends of the buffer springs abut against inner walls of front ends of the hollow locating pins, the front ends of the hollow locating pins stretch out of the side mounting through holes to be located in the lower adjustment groove and are inserted into a center groove formed in a middle of a rear wall surface of the first adjustment stop or the second adjustment stop, an inner wall surface of the center groove is an arc-shaped wall surface, front wall surfaces of the hollow locating pins are spherical wall surfaces and press against inner wall surfaces of the corresponding center grooves.

4. The high-precision and high-torsion ratchet wrench according to claim 1, wherein the first outer tooth part is located above the second outer tooth part, a first adjustment stop is located above a second adjustment stop, the first outer tooth part corresponds to the first adjustment stop, and the second outer tooth part corresponds to the second adjustment stop.

5. The high-precision and high-torsion ratchet wrench according to claim 1, wherein inner wall surfaces of left and right sides of the lower adjustment groove are arc-shaped wall surfaces, and left and right walls of a first adjustment stop and a second adjustment stop are matched with the arc-shaped wall surfaces of the lower adjustment groove.

6. The high-precision and high-torsion ratchet wrench according to claim 1, wherein a driving head which extends upwards vertically is disposed in a middle of a top surface of the ratchet head.

7. The high-precision and high-torsion ratchet wrench according to claim 1, wherein an extension which extends backwards is formed at a rear end of the handle head.

8. The high-precision and high-torsion ratchet wrench according to claim 1, wherein a steering gear comprises a bottom rotating part, a vertical column is formed on a top surface of a front portion of the bottom rotating part, and a rear wall surface of the vertical column clings to an inner wall of the mounting through hole; and a groove which extends backwards is formed in a bottom surface of the handle head at a bottom of the mounting through hole, a rear portion of the bottom rotating part is located in the groove, and a top surface of the rear portion of the bottom rotating part presses against a top surface of the groove.

9. The high-precision and high-torsion ratchet wrench according to claim 1, wherein a kidney-shaped groove is formed in the middle of the top surface of the handle head, the center mounting through hole, the lower adjustment groove and the mounting through hole are all located in a bottom surface of a middle of the kidney-shaped groove, a cover plate is inserted into the kidney-shaped groove, a bottom surface of the cover plate presses against a bottom surface of the kidney-shaped groove, and the cover plate is fixedly connected to the handle head through bolts.

10. The high-precision and high-torsion ratchet wrench according to claim 1, wherein the first outer tooth part and the second outer tooth part are each composed of 90 teeth, and the teeth of the first outer tooth part are longitudinally staggered with and correspond to the teeth of the second outer tooth part.
